(19) United States
(12) Patent Application Publication
(10) Pub. No.: US 2005/0252337 A1
(43) Pub. Date: Nov. 17, 2005

(54) Bicycle pedal assembly with an adjustable cleat-pushing member

(76) Inventor: Chung-I Chen, Taichung Hsien (TW)

Correspondence Address: LADAS & PARRY LLP, 224 SOUTH MICHIGAN AVENUE, SUITE 1600, CHICAGO, IL, 60604, US

(21) Appl. No.: 10/846,126

(22) Filed: May 14, 2004

(51) Int. Cl. G05G 1/14

(52) U.S. Cl. 74/594.6

(57) ABSTRACT

A bicycle pedal assembly includes a pedal body, a cleat, and a clamping unit for pressing a rear insert member of the cleat against a rear support portion of the pedal body. The pedal body includes a front support portion, a front stop element extending upwardly from a front end of the front support portion, and an upper stop element extending rearwardly from an upper end of the front stop element. A front insert member of the cleat is confined between the front support portion and the upper stop element of the pedal body. A cleat-pushing member is disposed movably on the pedal body, and is adjustable to press against the cleat. As such, the front insert member of the cleat is pressed against the upper stop element so as to prevent movement of the cleat relative to the pedal body.

### BACKGROUND OF THE INVENTION

1. Field of the Invention

This invention relates to a bicycle pedal assembly, and more particularly to a bicycle pedal assembly that includes a cleat-pushing member which is disposed movably on a pedal body and which is adjustable to press against a cleat so as to prevent movement of the cleat relative to the pedal body.

2. Description of the Related Art

Referring to FIGS. 1 and 2, a conventional pedal assembly for a bicycle is shown to include a cleat 11 connected fixedly to a cyclist's shoe 10, and a pedal 20.

The cleat 11 has a cleat body 111 made of a plastic material, a front insert member 112 connected fixedly to a front end of the cleat body 111, a rear insert member 113 connected fixedly to a rear end of the cleat body 111, and a metal plate (not shown) embedded within the cleat body 111.

The pedal 20 include a pedal body 21, a front retaining member 22 connected fixedly to a front end of the pedal body 21, a rear clamping unit 23 connected pivotally to the pedal body 21, and a spindle 24 extending into a shaft tube 211 of the pedal body 21. The pedal body 21 has a front support portion 212 extending integrally and forwardly from the shaft tube 211, a rear support portion 213 extending integrally and rearwardly from the shaft tube 211, and a cleat-supporting plate 214 connected fixedly to a top surface of the shaft tube 211. The front retaining member 22 is fixed on the front support portion 212. The rear clamping unit 23 includes a pivot pin 231 disposed on the rear support portion 213, two coiled torsional springs 232 sleeved on the pivot pin 231, and two clamping members 233 biased by the springs 232 to press the rear insert member 113 of the cleat 11 against the rear support portion 213.

The aforesaid conventional bicycle pedal assembly suffers from the following disadvantages:
(1) Walking of the cyclist that is wearing the shoe 10 with the cleat 11 will result in wear of the cleat 11. As such, when the cleat 11 is thereafter retained on the pedal body 21 between the front retaining member 22 and the rear clamping unit 23, it is likely that the cleat 11 will move relative to the pedal body 21 during pedaling of the cyclist, thereby resulting in loss of power transmitted from the cleat 11 to the pedal body 21.
(2) The front insert member 112 of the cleat 11 contacts the front retaining member 22 of the pedal body 20 on a surface (A) that is above a top surface (B) of the shaft tube 211. That is, the position of the surface (A) is relatively high relative to the shaft tube 211. Because the gravity center of the cyclist riding on the bicycle is relatively low, it is difficult for the cyclist to apply a comparatively large pedaling force to the surface (A), thereby limiting the speed of the bicycle.
(3) Wear of the cleat 10 will occur after the same is used for a period of time. Hence, there will be noise resulting from movement of the cleat 10 on the pedal body 21 during pedaling of the cyclist.

### SUMMARY OF THE INVENTION

An object of this invention is to provide a bicycle pedal assembly that includes a cleat-pushing member which is disposed movably on a pedal body and which is adjustable to press against a cleat so as to prevent movement of the cleat relative to the pedal body.

Another object of this invention is to provide a bicycle pedal assembly that has a pedal body which contacts a cleat at a position below a top surface of a shaft tube of the pedal body so that a cyclist can easily apply a comparatively large pedaling force to the pedal body.

According to this invention, a bicycle pedal assembly includes a cleat, a pedal body, a clamping unit, and a pushing unit. The cleat is adapted to be mounted fixedly to a shoe of a bicycle cyclist, and includes a fixed front insert member and a fixed rear insert member. The pedal body includes a shaft tube, a front support portion extending integrally and forwardly from the shaft tube, a front stop element extending integrally and upwardly from a front end of the front support portion, an upper stop element connected fixedly to and extending rearwardly from an upper end of the front stop element and confining the front insert member of the cleat between the front support portion of the pedal body and the upper stop element, and a rear support portion extending integrally and rearwardly from the shaft tube. The clamping unit includes a clamping member mounted pivotally on the rear support portion of the pedal body, and a resilient element interconnecting the clamping member and the rear support portion of the pedal body and biasing the clamping member to press the rear insert member of the cleat against the rear support portion of the pedal body. The pushing unit includes a cleat-pushing member disposed vertically and movably on the pedal body between the clamping unit and the upper stop element of the pedal body and movable relative to the pedal body to press against the cleat so as to press the front insert member of the cleat against the upper stop element of the pedal body, thereby preventing movement of the cleat relative to the pedal body.

In one preferred embodiment, the shaft tube of the pedal body has a top surface, and the upper stop element has a bottom surface that abuts against the front insert member of the cleat and that is disposed below the top surface of the shaft tube of the pedal body. Because the bottom surface of the upper stop element of the pedal body is relatively low relative to the shaft tube, the cyclist can easily apply a comparatively large pedaling force to the pedal body.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a conventional bicycle pedal assembly, a cleat being removed from a pedal body;

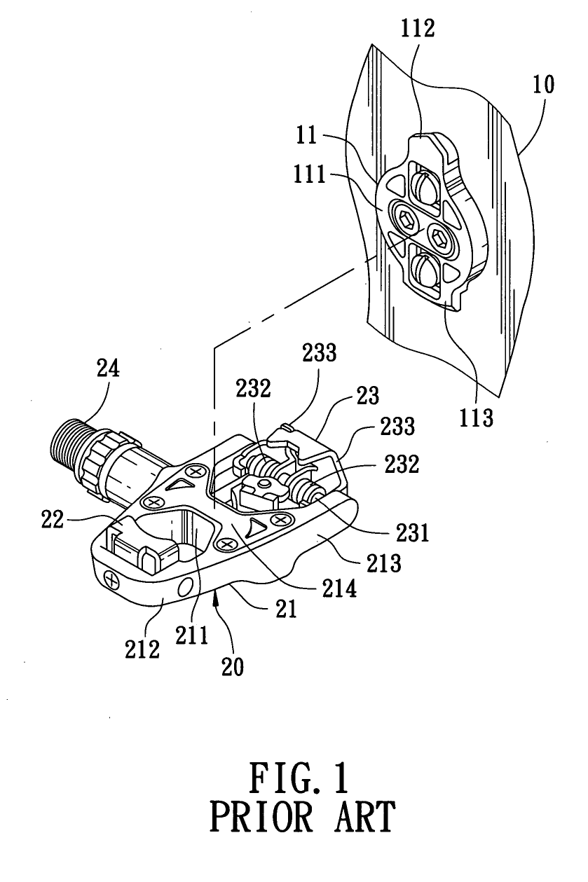

FIG. 2 is a perspective view of the conventional bicycle pedal assembly, the cleat being retained on the pedal body;

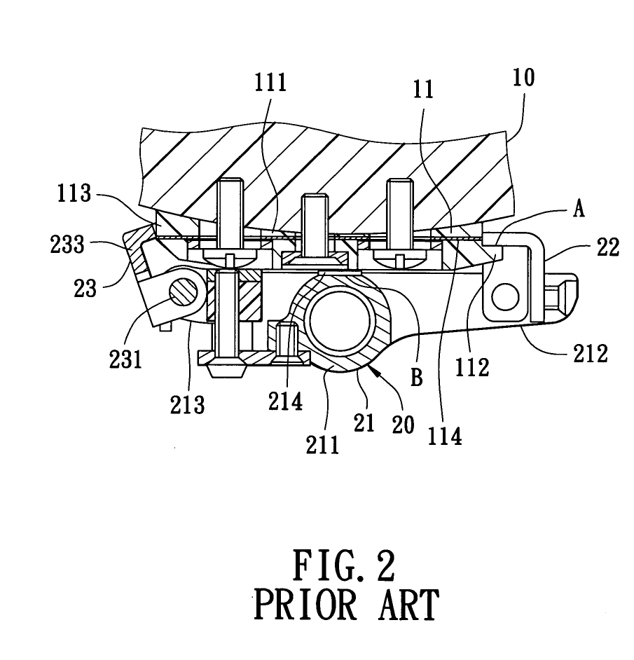

FIG. 3 is a partly exploded perspective view of the preferred embodiment of a bicycle pedal assembly according to this invention;

FIG. 4 is a perspective view of the preferred embodiment, a cleat being removed from a pedal body;

FIG. 5 is a sectional view of a shaft tube and a spindle of the preferred embodiment;

FIG. 6 is a top view of the preferred embodiment; and

FIG. 7 is a sectional view of the preferred embodiment.

### DETAILED DESCRIPTION OF THE PREFERRED EMBODIMENT

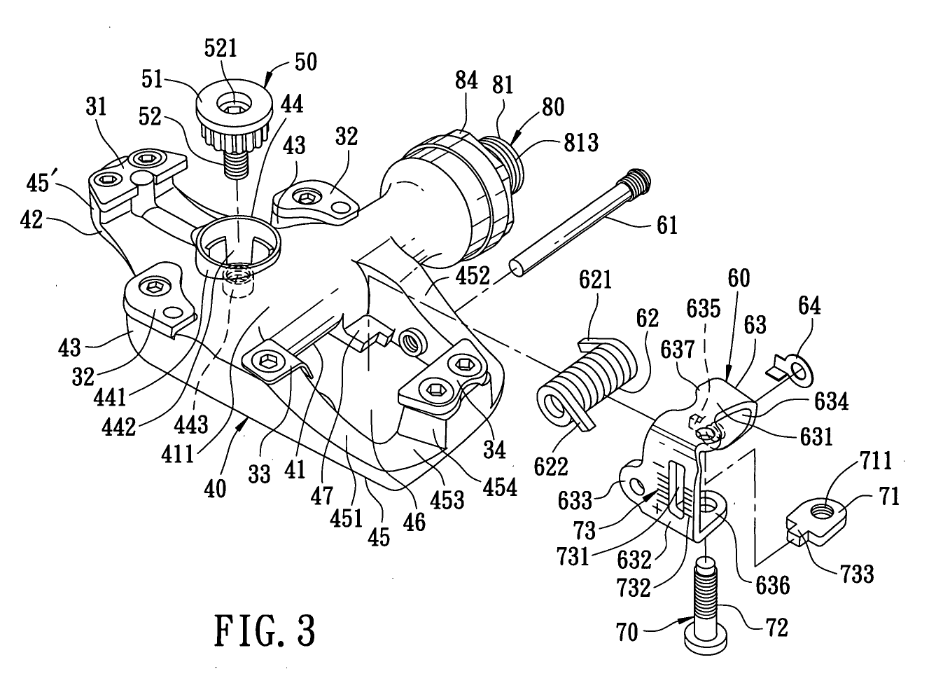

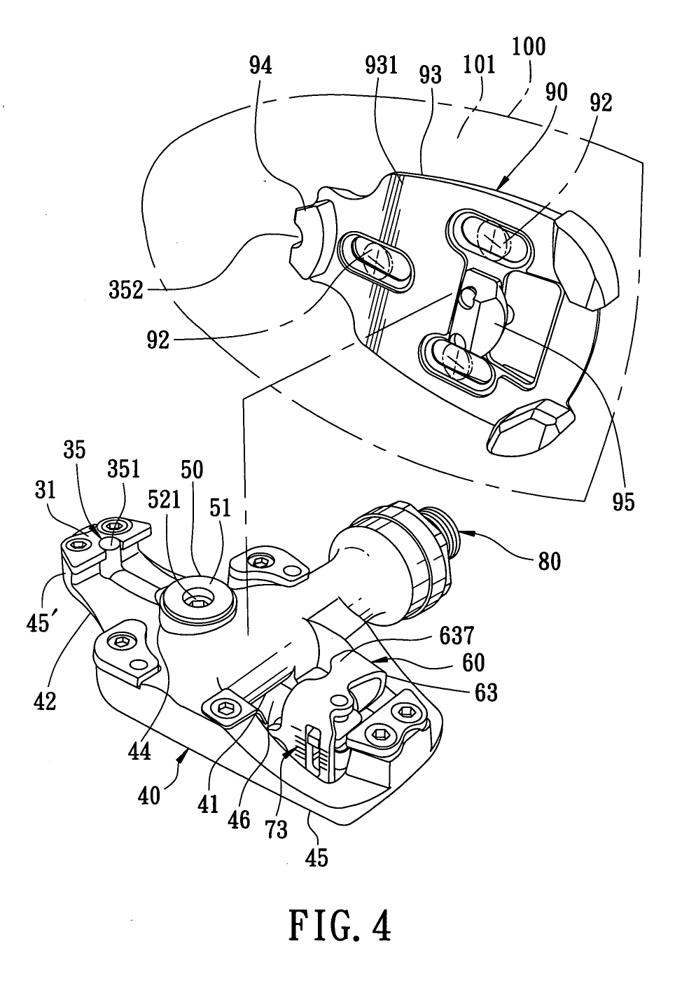

Referring to FIGS. 3 and 4, the preferred embodiment of a bicycle pedal assembly according to this invention is shown to include a pedal body 40, a pushing unit 50, a clamping unit 60, a clamping force-adjusting unit 70, a spindle unit 80, and a cleat 90.

The pedal body 40 includes a shaft tube 41 made of an aluminum or magnesium alloy, a front support portion 42 extending integrally and forwardly from the shaft tube 41, two side supporting seats 43 disposed at two opposite sides of the front support portion 42 and adjacent to the shaft tube 41, a middle supporting seat 44 disposed between the side supporting seats 43, and a rear support portion 45 extending integrally and rearwardly from the shaft tube 41. A front stop element 45′ extends integrally and upwardly from a front end of the front support portion 42.

The middle supporting seat 44 includes an annular projection 441 extending upwardly from the junction between the front support portion 42 and the shaft tube 41 to define a cylindrical accommodating space 442, and a threaded hole 443 formed in the pedal body 40 and communicated with a central portion of the accommodating space 442. The rear support portion 45 is U-shaped, and has a left arm 451, a right arm 452, a rear arm 453 having two ends formed respectively and integrally with rear ends of the left and right arms 451, 452, and a rear supporting seat 454 extending integrally and upwardly from a rear end of the rear support portion 45. The rear support portion 45 and the shaft tube 41 define a spring-receiving space 46 therebetween. An abutment member 47 is formed integrally with the shaft tube 41 and the right arm 452 of the rear support portion 45.

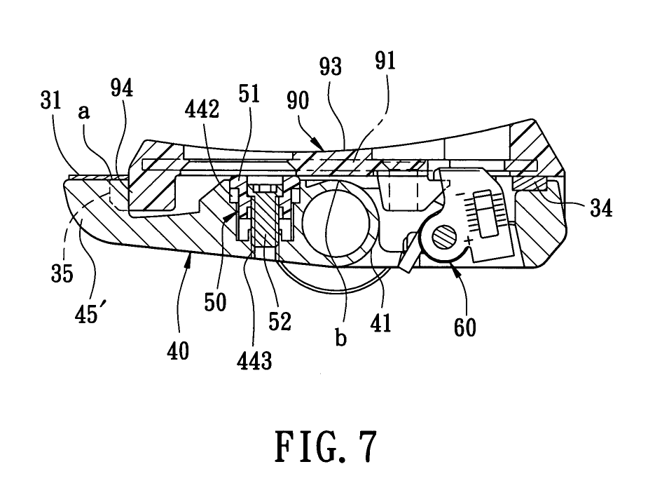

An anti-wear unit includes an upper stop element 31 configured as a horizontal anti-wear plate, two side stop elements 32 configured as horizontal anti-wear plates, an auxiliary anti-wear plate 33, and a rear stop element 34. The upper stop element 31 is connected threadedly to and extends rearwardly from an upper end of the front stop element 45′. The side stop elements 32 are connected respectively and threadedly to upper ends of the side supporting seats 43. The auxiliary anti-wear plate 33 is connected threadedly to a top surface of the left arm 451 of the rear support portion 45. The rear stop element 34 is connected threadedly to an upper end of the rear supporting seat 454. The pedal body 40 is made of a non-metal material. The upper stop element 31, the side stop elements 32, the auxiliary anti-wear plate 33, and the rear stop element 34 are made of metal. Alternatively, when the pedal body 40 is made of metal, the elements 31 to 34 may be formed integrally with the pedal body 40. The upper stop element 31 has a bottom surface (a) (see FIG. 7) that is disposed below a top surface (b) (see FIG. 7) of the shaft tube 41.

The pushing unit 50 includes an annular cleat-pushing member 51 disposed within the cylindrical accommodating space 442 in the pedal body 40 and disposed between the clamping unit 60 and the upper stop element 31, and a bolt member 52 engaging the threaded hole 443 in the pedal body 40 and having an upper end that is connected fixedly to a lower end of the cleat-pushing member 51, and a top surface that is formed with a hexagonal slot 521. The bolt member 52 can be rotated relative to the pedal body 40 by a tool (not shown) so as to move the cleat-pushing member 51 vertically toward and away from the pedal body 40. The cleat-pushing member 51 is made of a resilient material, such as rubber.

The clamping unit 60 includes a pivot pin 61 extending through the left and right arms 451, 452 of the rear support portion 45, a resilient element 62 sleeved on the pivot pin 61 and disposed within the spring-receiving space 46 in the pedal body 40, and a clamping member 63 sleeved rotatably on the pivot pin 61.

The clamping member 63 includes a top wall 631, a left side wall 632 having an upper end formed integrally with a left side of the top wall 631, a left pivot projection 633 extending integrally and forwardly from the left side wall 632, a right side wall 634 having an upper end formed integrally with a right side of the top wall 631, a right stop projection 635 extending integrally and forwardly from the right side wall 634 and abutting against the abutment member 47, a bottom wall 636 having a left side formed integrally with a lower end of the left side wall 632, and two clamping portions 637 extending respectively, integrally, and forwardly from two opposite sides of the top wall 631. The pivot pin 61 extends through the left pivot projection 633 and the right side wall 634.

The resilient element 62 is configured as a coiled torsional spring, and has a first end leg 621 pressing against the abutment member 47, and a second end leg 622.

A reinforcing member 64 is sleeved on the pivot pin 61, is made of metal, and is disposed between the right stop projection 635 and the abutment member 47 so as to prevent wear and deformation of the abutment member 47.

The clamping force-adjusting unit 70 includes: an adjusting member 71 with a threaded hole 711, the second end leg 622 of the resilient element 62 pressing against the adjusting member 71; and an adjustment bolt 72 extending through the bottom wall 636 and engaging the threaded hole 711 in the adjusting member 71. Rotation of the adjustment bolt 72 on the bottom wall 636 will cause the adjusting member 71 to move relative to the bottom wall 636, thereby varying the clamping force of the clamping member 63.

An indicating assembly 73 includes a slot 731 formed through the left side wall 632 of the clamping member 63, a scale 732 disposed on an outer surface of the left side wall 632, and an indicating element 733 extending integrally and leftwardly from the adjusting member 71 into the slot 731.

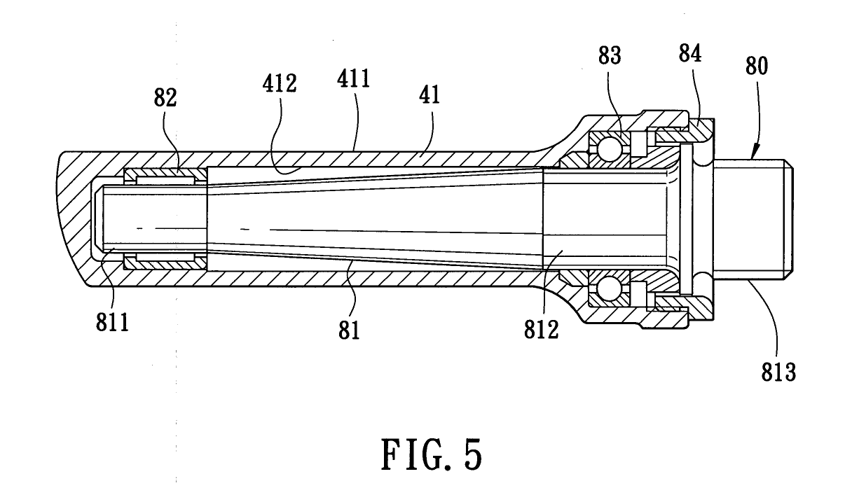

Referring to FIGS. 3 and 5, the spindle unit 80 includes a spindle 81, a bearing unit consisting of a roller bearing 82 and a ball bearing 83, and an externally threaded cap 84. The shaft tube 41 is sleeved rotatably on two opposite end portions 811, 812 of the spindle 81 by the roller bearing 82 and the ball bearing 83 so as to facilitate smooth rotation of the shaft tube 41 on the spindle 81. The cap 84 is connected threadedly to an internally threaded right end of the shaft tube 41. The spindle 81 has an externally threaded right end 813 extending from the shaft tube 41 for connection with a pedal crank (not shown).

Referring to FIGS. 4 and 7, the cleat 90 includes a cleat body 93 made of aplastic material, a horizontal metal plate 91 embedded within the cleat body 93, a plurality of bolts 92 for connecting the cleat body 93 to a bottom 101 of a cyclist's shoe 100, a front insert member 94 connected fixedly to a front end of a bottom surface 931 of the cleat body 93, and a rear insert member 95 connected fixedly to a rear portion of the cleat body 93. The front insert member 94 of the cleat 90 is confined between the front support portion 42 of the pedal body 40 and the upper stop element 31. The clamping portions 637 of the clamping member 63 are biased by the resilient element 62 to press the rear insert member 95 of the cleat 90 against the rear support portion 45 of the pedal body 40.

The front stop element 45′ has a planar rear surface that is formed with a curved projection 351. The front insert member 94 is formed with a curved groove 352 that engages fittingly the curved projection 351 of the front stop element 45′ so as to position the front insert member 94 of the cleat 90 relative to the front stop element 45′.

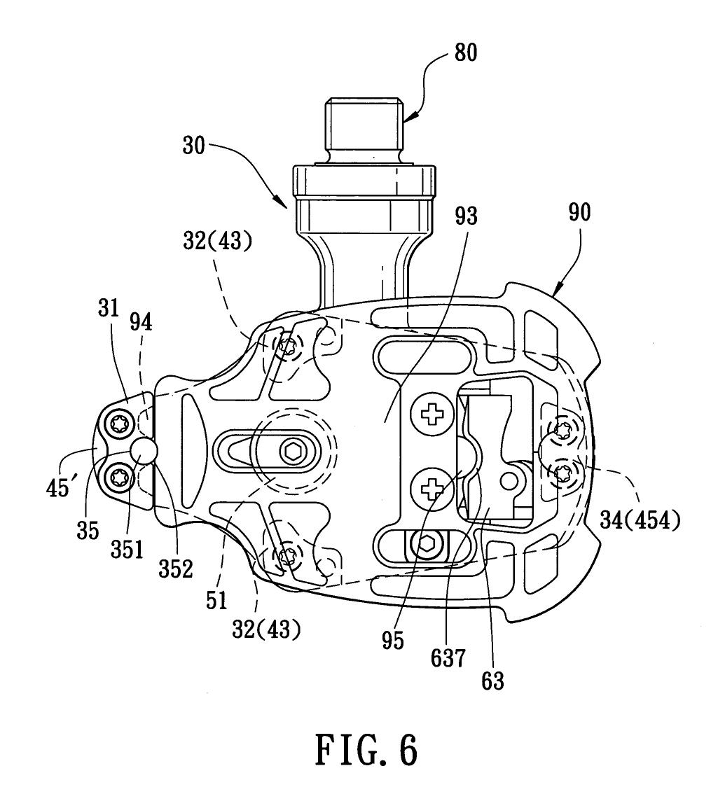

Referring to FIGS. 3, 4, 6, and 7, when it is desired to connect the cleat 90 with the pedal body 40, the front insert member 94 of the cleat 90 is moved to abut against the front stop element 45′. Subsequently, the rear insert member 95 of the cleat 90 is pressed downwardly against the clamping unit 60 so that it is clamped between the clamping unit 60 and the rear support portion 45 of the pedal body 40. As such, the bottom surface 931 of the cleat body 93 presses against the side stop elements 32 and the rear stop element 34.

When it is desired to remove the cleat 90 from the pedal body 40, it is only necessary to rotate the cleat 90 about the curved projection 351.

When wear of the cleat 90 occurs, the cleat-pushing member 51 can be moved relative to the pedal body 40 to press against the cleat 90 so as to press the front insert member 94 of the cleat 90 against the upper stop element 31, thereby preventing movement of the cleat 90 relative to the pedal body 40. Because the cleat-pushing member 51 is made of a resilient material, friction between the cleat-pushing member 51 and the cleat 90 is increased. As such, power can be transmitted effectively from the cleat 90 to the pedal body 40. Furthermore, noise resulting from the movement of the cleat 90 relative to the pedal body 40 can be prevented. Because the bottom surface (a) of the upper stop element 31 is disposed below the top surface (b) of the shaft tube 41, the cyclist (not shown) riding on the bicycle can easily apply a comparatively large pedaling force to the pedal body 40.

With this invention thus explained, it is apparent that numerous modifications and variations can be made without departing from the scope and spirit of this invention. It is therefore intended that this invention be limited only as indicated by the appended claims.

1. A bicycle pedal assembly comprising:
a cleat adapted to be mounted fixedly to a shoe of a bicycle cyclist and including a fixed front insert member and a fixed rear insert member;
a pedal body including
a shaft tube,
a front support portion extending integrally and forwardly from said shaft tube,
a front stop element extending integrally and upwardly from a front end of said front support portion,
an upper stop element connected fixedly to and extending rearwardly from an upper end of said front stop element and confining said front insert member of said cleat between said front support portion of said pedal body and said upper stop element, and
a rear support portion extending integrally and rearwardly from said shaft tube;
a clamping unit including a clamping member mounted pivotally on said rear support portion of said pedal body, and a resilient element interconnecting said clamping member and said rear support portion of said pedal body and biasing said clamping member to press said rear insert member of said cleat against said rear support portion of said pedal body; and
a pushing unit including a cleat-pushing member disposed vertically and movably on said pedal body between said clamping unit and said upper stop element of said pedal body and adapted to be moved relative to said pedal body to press against said cleat so as to press said front insert member of said cleat against said upper stop element of said pedal body, thereby preventing movement of said cleat relative to said pedal body.

2. The bicycle pedal assembly as claimed in claim 1, wherein said cleat-pushing member of said pushing unit is made of a resilient material so as to increase friction between said cleat-pushing member and said cleat.

3. The bicycle pedal assembly as claimed in claim 1, wherein said pedal body is formed with a threaded hole, said pushing unit further including a bolt member that engages said threaded hole in said pedal body and that has an upper end which is connected fixedly to a lower end of said cleat-pushing member, said bolt member being rotatable relative to said pedal body so as to move said cleat-pushing member toward and away from said pedal body.

4. The bicycle pedal assembly as claimed in claim 1, wherein said front stop element of said pedal body has a planar rear surface that is formed with a curved projection, said front insert member of said cleat being formed with a curved groove that engages fittingly said projection of said front stop element of said pedal body so as to position said front insert member of said cleat relative to said front stop element of said pedal body.

5. The bicycle pedal assembly as claimed in claim 1, wherein said upper stop element of said pedal body is configured as a horizontal anti-wear plate that is made of metal.

6. The bicycle pedal assembly as claimed in claim 1, wherein said shaft tube of said pedal body has a top surface, said upper stop element having a bottom surface that abuts against said front insert member of said cleat and that is disposed below said top surface of said shaft tube of said pedal body.

7. The bicycle pedal assembly as claimed in claim 1, further comprising:
a spindle extending into said shaft tube of said pedal body; and
a bearing unit including a roller bearing and a ball bearing that are sleeved respectively on two end portions of said spindle and that are disposed within said shaft tube of said pedal body so that said shaft tube of said pedal body is sleeved rotatably on said spindle.
